(19) United States
(12) Patent Application Publication
(10) Pub. No.: US 2024/0305465 A1
(43) Pub. Date: Sep. 12, 2024

(54) ARTIFICIAL INTELLIGENCE MODEL ACCURACY VALIDATION

(71) Applicant: Intel Corporation, Santa Clara, CA (US)

(72) Inventors: Anjo Lucas Vahldiek-Oberwagner, Berlin (DE); Marcin Andrzej Chrapek, Zurich (CH); Scott Constable, Portland, OR (US)

(21) Appl. No.: 18/665,188

(22) Filed: May 15, 2024

(51) Int. Cl. H04L 9/32

(52) U.S. Cl. CPC H04L 9/3236

(57) ABSTRACT

Systems, apparatus, methods, and articles of manufacture to validate the accuracy of artificial intelligence models are disclosed. An example apparatus includes machine-readable instructions; and at least one processor circuit to be programmed by the machine-readable instructions to: compute accuracy statistics of an artificial intelligence model using software applied by a trusted third party and an input data set; determine a signed artifact based on (1) the accuracy statistics indicative of the accuracy of the artificial intelligence model, (2) the software applied by the trusted third party, and (3) the input data set; and communicate the signed artifact to a user of the artificial intelligence model.

### BACKGROUND

When an artificial intelligence model is proprietary, external stakeholders and customers cannot validate the accuracy of the model and must trust the model owner's assertions.

### BRIEF DESCRIPTION OF THE DRAWINGS

FIG. 1 is a block diagram of an example environment including example accuracy evaluation circuitry and an example user of an example artificial intelligence model.

FIG. 2 is a block diagram of an example artifact of FIG. 1.

FIG. 3 is a flowchart representative of example machine readable instructions and/or example operations that may be executed, instantiated, and/or performed by example programmable circuitry to implement the accuracy evaluation circuitry 100 of FIG. 1.

FIG. 4 is a flowchart representative of example machine readable instructions and/or example operations that may be executed, instantiated, and/or performed by example programmable circuitry to implement the user 150 of FIG. 1.

FIG. 5 is a block diagram of an example processing platform including programmable circuitry structured to execute, instantiate, and/or perform the example machine readable instructions and/or perform the example operations of FIG. 3 to implement the accuracy evaluation circuitry 100 of FIG. 1 and/or the example operations of FIG. 4 to implement the user 150 of FIG. 1.

FIG. 6 is a block diagram of an example implementation of the programmable circuitry of FIG. 5.

FIG. 7 is a block diagram of another example implementation of the programmable circuitry of FIG. 5.

FIG. 8 is a block diagram of an example software, firmware, and/or instructions distribution platform (e.g., one or more servers) to distribute software, instructions, and/or firmware (e.g., corresponding to the example machine readable instructions of FIGS. 3 and/or 4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Generative artificial intelligence (AI) models such as large language models (LLMs) are typically huge. Accuracy of a model can degrade even after the model has been trained. For example, a model owner or machine learning as a service (MLaaS) host may quantize or approximate the model to improve performance (or reduce power consumption, etc.). These benign or malicious adjustments to the trained model can in some cases drastically reduce the model accuracy. In some examples, model accuracy is crucial in use cases with catastrophic implications such as, for example, medical software, robotics, or self-driving cars. A reduction in accuracy of object detection models in self-driving cars, tumor selection models in healthcare, or LLMs automatically answering customer questions could lead to business loss or death. This is particularly important when models are frequently updated to allegedly improve their accuracy. In addition, model owners and MLaaS owners are interested in improving the efficiency to lower the cost of MLaaS. Improving performance, e.g., via quantization can in some cases drastically reduce accuracy of the models. These effects have been observed in the most widely used model today GPT 3.5 and 4. As a result, continuously ensuring accuracy of the used model is of high importance.

With models such as GPT4 reaching trillions of parameters, even inference is expensive. Currently any accuracy numbers and example inference results provided by model owners such as scientific authors or model sellers hold no guarantees. In some examples, the reviewers and buyers put no trust in these example accuracy numbers and inference results and assess them using common sense or by comparing the accuracy numbers and inference results against competitor claims, which may mislead the decisionmakers. In some examples, an internal investigation is used to reproduce the results to verify accuracy. In some examples, such verification process is repeated multiple times, across different companies or reviewers, each wasting their resources on an activity that has been already completed by the model owner on standard datasets. For example, a service seller might offer their model to thousands of hospitals, and each would conduct an internal evaluation.

In some examples, accuracy evaluation may be initially performed by a model owner after the training and fine-tuning of a model is complete. The model owner performs the accuracy evaluation with a standardized validation data set to compute the accuracy as defined by the test. Users of the model 102 decide which model to pick and perform their inference with the preferred model. Without accuracy guarantees, capabilities of a model cannot be compared to other models. In an industrial setting, customers and model users expect to buy a model of a certain quality and updates to improve the model. As a result, model accuracy tests are repeated to demonstrate the accuracy in a trusted environment.

Examples disclosed herein enable users of AI models to validate the accuracy of the AI model. In some examples, trusted environments are leveraged. Trusted execution environments (TEEs) are the foundation of Confidential Computing (CC). TEEs help to secure data in storage, in transit, and in use, protecting from untrustworthy privileged software (e.g., the operating system (OS)/virtual machine monitor (VMM)—i.e., a hypervisor). TEEs, for example, allow the users to avoid sharing their IP with the computation platform owners such as cloud service providers (CSPs). TEEs provide confidentiality of the data and integrity of code by conducting computation in secure memory regions called the enclaves. TEEs are used to secure applications in disciplines such as, for example, finance and healthcare and allow remote parties to attest computations as a black box of known inputs, code, and entry points generated a certain output.

Repeating the accuracy tests are not always possible, due to the limited performance of the end-user devices and the complexity of some accuracy tests. For example, for models sold to multiple customers or published in a journal, each stakeholder (company, reviewer, etc.) must run the model on accuracy benchmarks to verify the owner's quality claims, performing redundant and wasteful work. Hence, if there are n users of a model and it costs C_{model} resources (e.g., dollars, watts, etc.) to run the model over some i different inputs, then the total cost for all users to independently verify the accuracy claim is defined by:

$$Total Cost = n \times i \times {c}_{model} \qquad Equation ( 1 )$$

This is especially wasteful when n and C_{model} are large, as is often the case for billion/trillion-parameter models such as LLMs.

Examples disclosed herein reduce the amount of work from the Total Cost of Equation (1) to:

$$Total Cost = i \times {c}_{model} + n \times {c}_{sig} \qquad Equation ( 2 )$$

where C_{sig} is the cost to verify a cryptographically signed artifact that attests to the accuracy of a model for a given validation dataset. Hence, the relatively large factors n and C_{model} scale separately with the relatively small factors i and C_{sig}, respectively.

Examples disclosed herein avoid costly reproduction of results and overcome trust issues when owners endorse accuracy guarantees. Examples disclosed herein leverage TEEs (e.g., Software Guard Extension (SGX) and Trust Domain Extension (TDX)) to allow users to trust the accuracy and quality guarantees provided by the model owners. Examples disclosed herein information (e.g., evaluation dataset, model architecture & weights) for model evaluation as an input to a TEE, performs the accuracy evaluation inside the TEE, and generates a cryptographically signed result (e.g., accuracy endorsement) combining the definition of the input, the platform specification of the TEE, and code (e.g., software used to evaluate the accuracy of the AI model). The signed result can then be shared with interested parties (e.g., users) that can verify the computed result, used hardware platform, evaluation dataset, and so on. This allows end users to place trust in the model's quality without blindly trusting the model owner or MLaaS.

Examples disclosed herein cryptographically couple the accuracy endorsement of accuracy results to the platform and code specifications that computed the results, which allows external partners to validate the endorsement. Examples disclosed herein also lower the overhead for trust in the endorsement to external stakeholders, which reduces the wasted resources. Also, examples disclosed herein make the decision process of decisionmakers more accurate, faster, and trustworthy. In some examples, the signed endorsement can be automatically detected and validated.

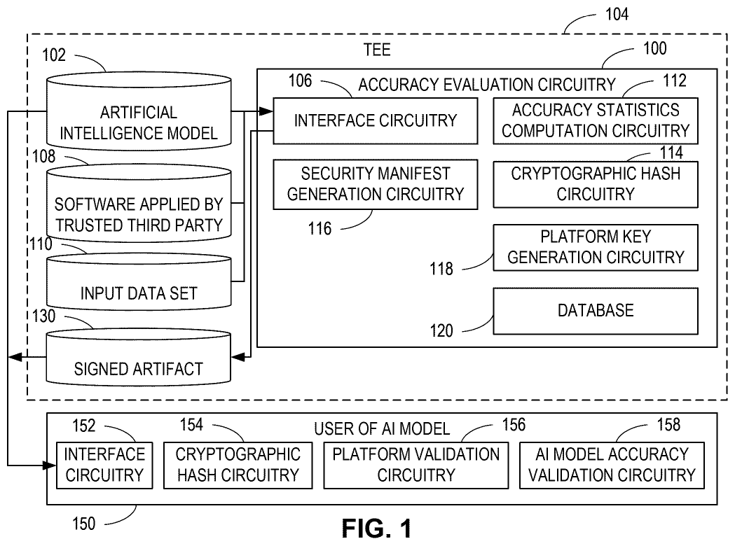

FIG. 1 is a block diagram of an example environment including example accuracy evaluation circuitry 100 of an example artificial intelligence (AI) model 102. The AI model 102 may be referred to herein as the model 102. The example accuracy evaluation circuitry 100 operates in an example TEE 104. The accuracy evaluation circuitry 100 includes example interface circuitry 106 to obtain, access, retrieve, or receive inputs including, for example, the AI model 102, example code or software used by the trusted third party 108 for accuracy evaluation, and example validation date or input data set 110.

The accuracy evaluation circuitry 100 also includes example accuracy statistic computation circuitry 112, example cryptographic hash circuitry 114, example security manifest generation circuitry 116, example platform key generation circuitry 118, and an example database 120.

The accuracy evaluation circuitry 100 generates an example signed artifact 130, which is communicated to an examiner user 150 of the AI model. The user 150 includes example interface circuitry 152, example cryptographic hash circuitry 154, example platform validation circuitry 156, and example AI model validation circuitry 158. The user 150 uses the signed artifact 130 to verify accuracy of the AI model 102. Thus, the signed artifact 130 is used to verifiably communicate the accuracy of the AI model 102. In some examples, the signed artifact 130 is referred to as the artifact 130. Also, in some examples, the signed artifact 130 is referred to as an accuracy endorsement and/or a trustworthy accuracy guarantee.

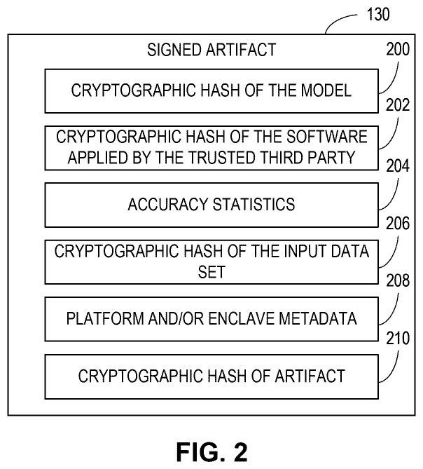

The signed artifact 130 is a data packet that includes information that can be used to verify how the accuracy of the AI model 102 was evaluated and how the accuracy value was obtained during the process. FIG. 2 is a block diagram showing example components of the example signed artifact 130. In some examples, the signed artifact 130 includes an example cryptographic hash of the model 200, example cryptographic hash of the software applied by the trusted third party 202, example accuracy statistics 204, an example cryptographic hash of the input data set 206, example platform and/or enclave meta 208, and an example cryptographic hash of the artifact 210.

In some examples, the cryptographic hash of the model 200 includes a representation of the model 102 as the model 102 exists in storage, in memory, and/or as some other representation (e.g., a compressed representation). The signed artifact 130 may also include metadata such as the model name, version, number of parameters, etc.

In some examples, the cryptographic hash of the software applied by the trusted third party 202 includes a cryptographic hash of the code or software used by the trusted third party 108 that directs the trusted third party for how to compute accuracy evaluation. In some examples, the software applied by the trusted third party 108 is standardized (i.e., by a community), open source, or specialized. In some examples, the software applied by the trusted third party 108 is from a third party independent from the creator or owner of the AI model 102. In some examples, the software applied by the trusted third party 108 is derived from more than one source.

In some examples, the accuracy statistics 204 are generated, computed, and/or other determined by the accuracy evaluation circuitry 100 as disclosed herein. In some examples, the accuracy statistic 204 can be a numerical value (e.g., 99.2% or other value) and/or a numerical value with a description (e.g., for an AI model to classify flowers: 99% accurate at classifying roses, 90% accurate at classifying tulips, and 95% accurate at classifying daffodils).

In some examples, the cryptographic hash of the input data set 206 includes a hash of the input data set 110 that were used to generated the accuracy statistic 204. In some examples, the input data set 110 is referred to as validation data. In some examples, the input data set 110 is standardized (i.e., by a community), open source, or specialized. In some examples, the input data set 110 is from a third party independent from the creator or owner of the AI model 102. In some examples, the input data set 110 is derived from more than one source.

In some examples, the platform and/or enclave meta 208 includes information related to the hardware used in the TEE by the trusted third party to operate the software applied by the trusted third party 108.

In some examples, the cryptographic hash of the artifact include a cryptographic hash of the other contents (i.e., of 202, 204, 208, and 208) of the artifact 130 that are signed by a key of the TEE 104.

The TEE 104 is a central processing unit (CPU) and/or or graphics processing unit (GPU) capability that provides a special compute environment within a process in case of SGX or within a virtual machine (VM) in case of TDX. In some examples, the environment enclave refers to both process-based TEEs and VM-based TEEs. Other examples include TEEs in other types of accelerators and/or other types of TEEs. The lifecycle of an enclave follows three stages: 1) initialization and measurement, 2) compute, 3) result attestation. During the initialization, the CPU enforces and measures the loaded code and input arguments to ensure that only certain programs are loaded into the enclave. The compute phase performs the calculations as described by the code and input arguments. The result attestation phase uses the measurements collected during the initialization phase and capabilities of the CPU-provided TEE to cryptographically sign the result (e.g., the cryptographic hash of the artifact 210). The signature allows remote parties to verify that a specific platform performed the computation and was given the measured code and input arguments. During this time, the CPU ensures the confidentiality and integrity of the computation by encrypting the memory. This ensures that the initial measurements and the computation cannot be tampered with from any other software running on the platform (e.g., privileged hypervisors, or operating systems).

To facilitate use of TEEs, software frameworks (SWF) provide abstractions for measuring and building trusted applications and inputs. In some examples, SWFs such as Gramine provide a security abstraction for applications running inside TEEs that automatically measures all inputs such as files or arguments before any access is allowed by the application. This is enforced with a security monitor running side-by-side in the TEE. This monitor is loaded first, measured, and then provides software-based enforcement of file SHA256 values and arguments. The list of allowed files is specified in a security manifest which is provided to the TEE at startup and part of the measurement.

Combining the TEE measurement and the runtime enforcement of file integrity hashes, allows an attestor to use the measurements of the TEE to ensure that a certain application is running with the specified arguments and input files. Examples disclosed herein leverage such software framework to provide the abstraction needed to produce a trustworthy accuracy result of an LLM. Based on the input data (e.g., the model 102, the software applied by the trusted third party 108, the input data set 110, etc.) and the cryptographic hashes of FIG. 2, a security manifest is generated. This security manifest ensures that the accuracy evaluation is started if and/or when the TEE 104 correctly initializes and loads the correct the model 102, the software applied by the trusted third party 108, and the input data set 110. With this security manifest, the SWF can load a TEE including the security manifest, measure its initial memory footprint, and receive a signed report about the measurement (e.g., EREPORT instruction in SGX). If the integrity check of the SWF succeeds, the accuracy evaluation circuitry 108 generates an accuracy report of the model 102. Using the measurement and the capabilities of the TEE 104 to generate keys (e.g., EGETKEY instruction in SGX) based on the initial measurement (e.g., MRENCL key), the TEE 104 combines the accuracy report, and the TEE's measurement report by signing it with the generated key. This key allows third parties to validate that a genuine TEE performed this evaluation.

Any or all of the AI model 102, the software applied by the trusted third party 108, the input data set 110, the security manifest, the platform key, cryptographic hashes, and/or the signed artifact 130 are storable and/or retrievable from the database 120.

The user 150 validates the signed artifact 130. The user 150 validates the correctness of the TEE platform and checks that the currently used model 102 matches the model mentioned in the signed artifact 130. Further checks could be performed to ensure that the accuracy evaluation relied on the correct validation data (input data set 110) and code (software applied by the trusted third party 108).

FIG. 1 is a block diagram of an example implementation of the accuracy evaluation circuitry 100 and an example implementation of the user 150 to validate or evaluate the accuracy of an AI model. The accuracy evaluation circuitry 100 and/or the user 150 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the accuracy evaluation circuitry 100 and/or the user 150 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

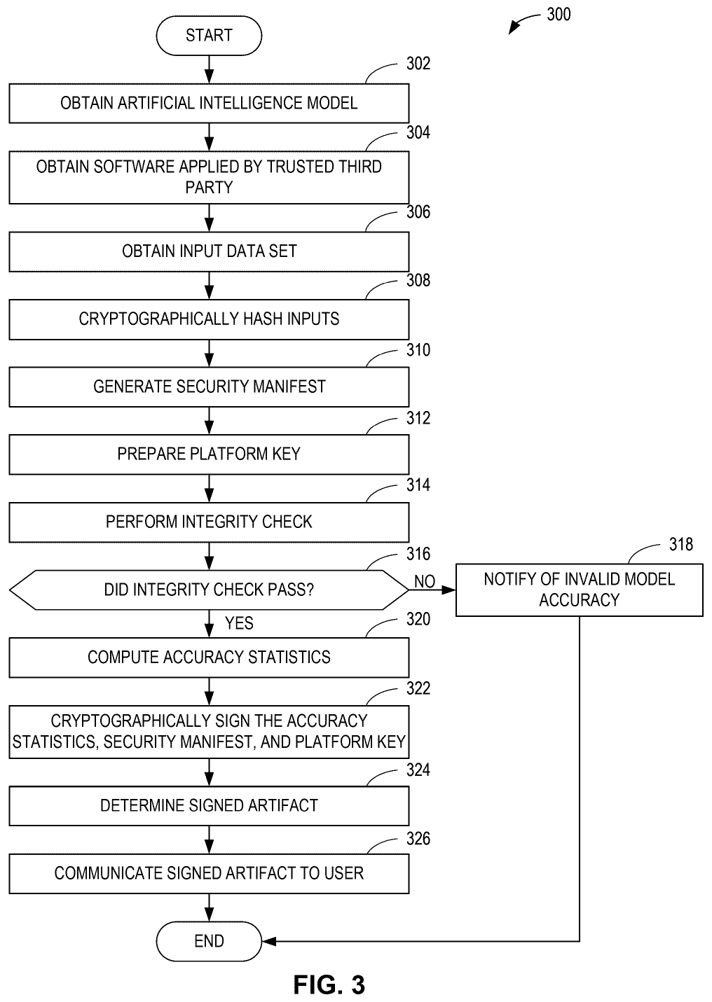

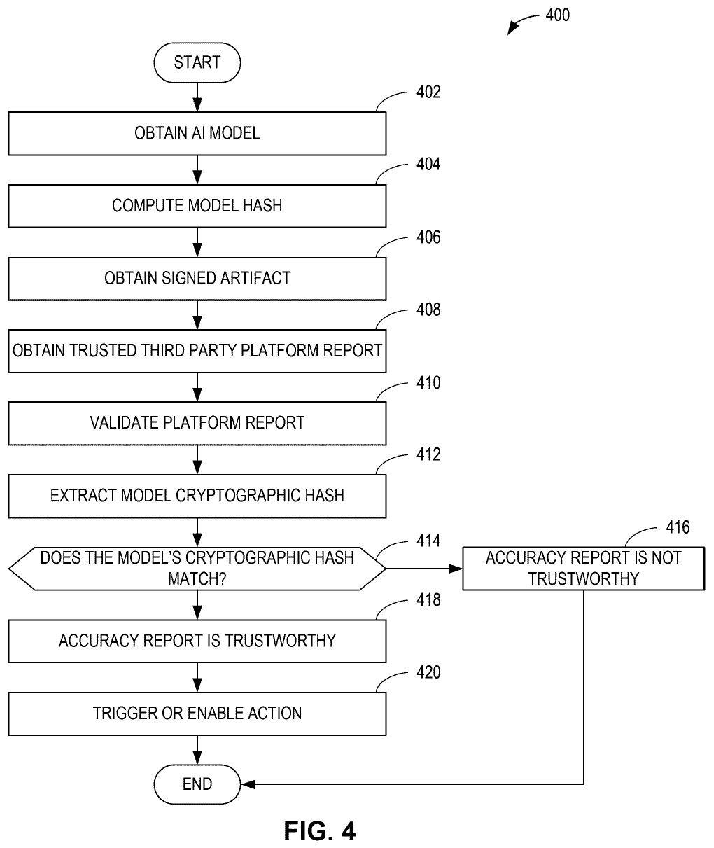

In some examples, the accuracy evaluation circuitry 100 is instantiated by programmable circuitry executing accuracy evaluation instructions and/or configured to perform operations such as those represented by the flowchart(s) of FIG. 3. In some examples, the circuitry of the user 150 is instantiated by programmable circuitry executing accuracy evaluation instructions and/or configured to perform operations such as those represented by the flowchart(s) of FIG. 4.

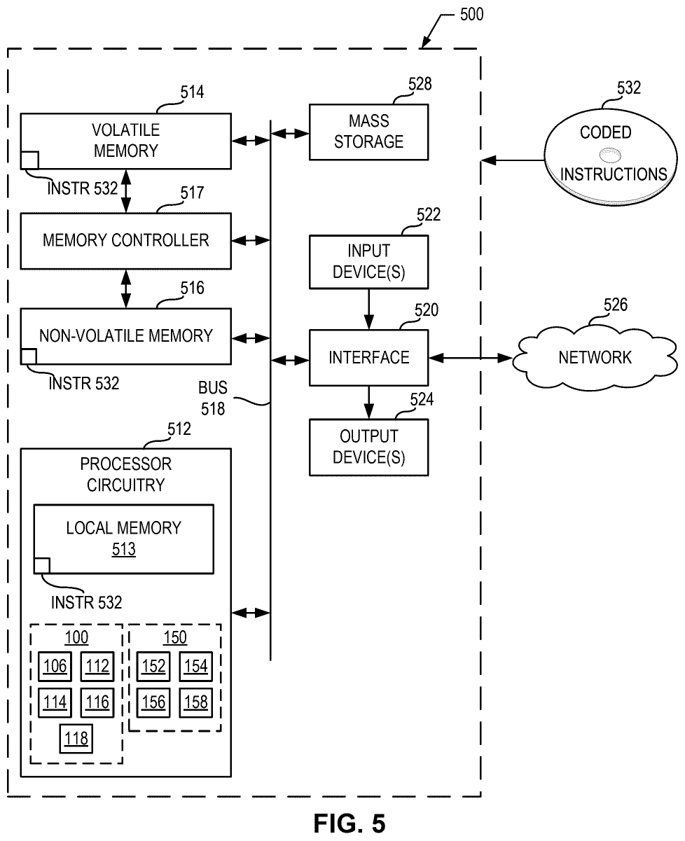

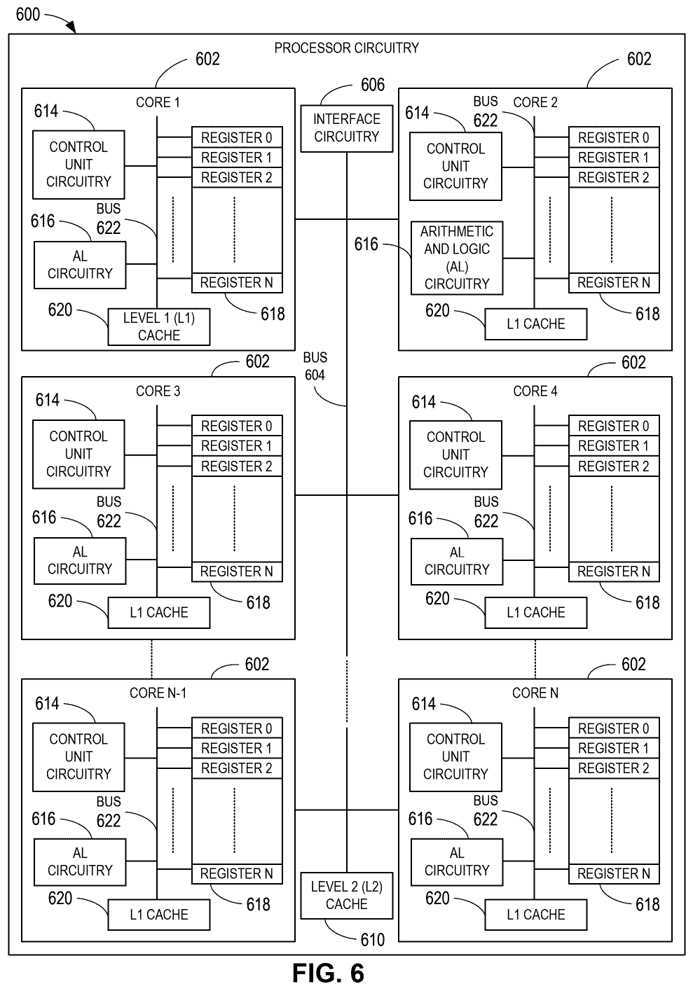

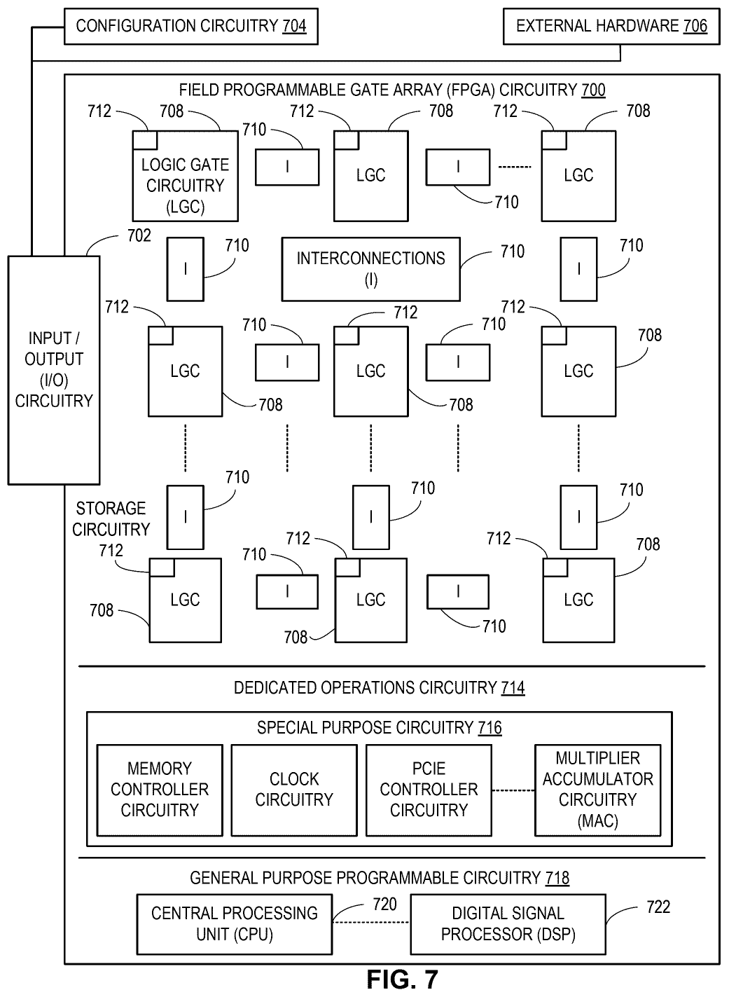

In some examples, the accuracy evaluation circuitry 100 and/or the circuitry of the user 150 includes means for determining, validating, and/or evaluating the accuracy of an AI model. For example, the means for determining, validating, and/or evaluating may be implemented by the circuitry of FIG. 1. In some examples, the circuitry of FIG. 1 may be instantiated by programmable circuitry such as the example programmable circuitry 512 of FIG. 5. For instance, the circuitry of FIG. 1 may be instantiated by the example microprocessor 600 of FIG. 6 executing machine executable instructions such as those implemented by at least blocks 702, 704 of FIG. 7. In some examples, the circuitry of FIG. 1 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the circuitry of FIG. 1 may be instantiated by any other combination of hardware, software, and/or firmware. For example, the circuitry of FIG. 1 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the accuracy evaluation circuitry 100 is illustrated in FIG. 1, one or more of the elements, processes, and/or devices illustrated in FIG. 1 may be combined, divided, re-arranged, omitted, eliminated, and/or implemented in any other way. Further, the example interface circuitry 106, the example accuracy statistics computation circuitry 112, the example cryptographic hash circuitry 114, the example security manifest generation circuitry 116, the example platform key generation circuitry 118, the example database 120, and/or, more generally, the example accuracy evaluation circuitry 100 of FIG. 1, may be implemented by hardware alone or by hardware in combination with software and/or firmware. Thus, for example, any of the example interface circuitry 106, the example accuracy statistics computation circuitry 112, the example cryptographic hash circuitry 114, the example security manifest generation circuitry 116, the example platform key generation circuitry 118, the example database 120, and/or, more generally, the example accuracy evaluation circuitry 100, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example accuracy evaluation circuitry 100 of FIG. 1 may include one or more elements, processes, and/or devices in addition to, or instead of, those illustrated in FIG. 1, and/or may include more than one of any or all of the illustrated elements, processes and devices.

Also, while an example manner of implementing the user 150 is illustrated in FIG. 1, one or more of the elements, processes, and/or devices illustrated in FIG. 1 may be combined, divided, re-arranged, omitted, eliminated, and/or implemented in any other way. Further, the example interface circuitry 152, the example cryptographic hash circuitry 154, the example platform validation circuitry 156, the example AI model accuracy validation circuitry 158, and/or, more generally, the example user 150 of FIG. 1, may be implemented by hardware alone or by hardware in combination with software and/or firmware. Thus, for example, any of the example interface circuitry 152, the example cryptographic hash circuitry 154, the example platform validation circuitry 156, the example AI model accuracy validation circuitry 158, and/or, more generally, the example user 150, could be implemented by programmable circuitry in combination with machine readable instructions (e.g., firmware or software), processor circuitry, analog circuit(s), digital circuit(s), logic circuit(s), programmable processor(s), programmable microcontroller(s), GPU(s), DSP(s), ASIC(s), PLD(s), and/or FPLD(s) such as FPGAs. Further still, the example user 150 of FIG. 1 may include one or more elements, processes, and/or devices in addition to, or instead of, those illustrated in FIG. 1, and/or may include more than one of any or all of the illustrated elements, processes and devices.

Flowchart(s) representative of example machine readable instructions, which may be executed by programmable circuitry to implement and/or instantiate the accuracy evaluation circuitry 100 and/or the user 150 of FIG. 1 and/or representative of example operations which may be performed by programmable circuitry to implement and/or instantiate the accuracy evaluation circuitry 100 and/or the user 150 of FIG. 1, are shown in FIGS. 3 and/or 4. The machine readable instructions may be one or more executable programs or portion(s) of one or more executable programs for execution by programmable circuitry such as the programmable circuitry 512 shown in the example processor platform 500 discussed below in connection with FIG. 5 and/or may be one or more function(s) or portion(s) of functions to be performed by the example programmable circuitry (e.g., an FPGA) discussed below in connection with FIGS. 6 and/or 7. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3 and/or 4, many other methods of implementing the example accuracy evaluation circuitry 100 and/or the user 150 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3 and 4 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations 300 that may be executed, instantiated, and/or performed by programmable circuitry to evaluate or validate the accuracy of an AI model and determine or generate a signed artifact related thereto. The example machine-readable instructions and/or the example operations 300 of FIG. 3 begin with the accuracy evaluation circuitry 100 accessing, receiving, retrieving, or obtaining the AI model 102 (block 302). The accuracy evaluation circuitry 100 also accesses, receives, retrieves, or obtains the software applied by the trusted third party 108 (block 304). In addition, the accuracy evaluation circuitry 100 accesses, receives, retrieves, or obtains the input data set 110 (block 306). The AI model 102, the software applied by the trusted third party 108, and the input data set 110 may all be accessed, received, retrieved, or obtained by the accuracy evaluation circuitry 100 via the interface circuitry 106 of the accuracy evaluation circuitry 100. The AI model 102, the software applied by the trusted third party 108, and the input data set 110 may be collectively referred to as the inputs. The cryptographic hash circuitry 114 of the accuracy evaluation circuitry 100 cryptographically hashes the inputs (block 308).

The security manifest generation circuitry 116 generates a security manifest (block 310). In some examples, the security manifest is based on the cryptographic hash of the AI model 102, the cryptographic hash of the software applied by the trusted third party 108, and the cryptographic hash of the input data set 110. In some examples, the security manifest includes other information related to software licenses, approved programs, other details related to the software framework and/or other metadata. The platform key generation circuitry 118 prepares the platform key (block 312). The platform key includes details related to the hardware used in the AI model accuracy evaluation and validation.

The accuracy evaluation circuitry 100 performs an integrity check based on the security manifest and the platform key (block 314). In some examples, the AI model accuracy evaluation process is operating in the TEE 104. There may be an operating system running software beneath the TEE 104 that is not trusted. The data output from such software may not be trusted and needs to be checked with the integrity check. For example, some data, even a single bit, may be modified maliciously or inadvertently. Such modification could cause the integrity check to fail, which is indicative that there is data that cannot be trusted. If and/or when the accuracy evaluation circuitry 100 determines that the integrity check did not pass (block 316: NO), the accuracy evaluation circuitry 100 notifies of an invalid model accuracy (block 318). For example, the accuracy evaluation circuitry 100 may communicate a notification via the interface circuitry 106 of the accuracy evaluation circuitry 100 to, for example, the user 150 that the accuracy of the AI model 102 has not been validated. After notification of the invalid model accuracy (block 318), the process 300 ends.

If and/or when the accuracy evaluation circuitry 100 determines that the integrity check did pass (block 316: YES), the accuracy statistics computation circuitry 112 determines, derives, calculates, and/or computes the accuracy statistics (block 320). For example, the accuracy statistics computation circuitry 112 runs the software applied by the trusted third party 108 on the input data set 110 using the AI model 102.

The cryptographic hash circuitry 114 cryptographically signs the accuracy statistics, security manifest, and platform key (block 322). The accuracy evaluation circuitry 100 compiles, generates, or determines the signed artifact 130 (block 324). The accuracy evaluation circuitry 100 communicates or causes communication of the signed artifact 130 to the user 150 (block 326). For example, the signed artifact 130 is communicated to the user 150 via the interface circuitry 106 of the accuracy evaluation circuitry 100. The process 300 then ends until the process 300 is initiated again. The process 300 may be automatically initiated anytime the AI model 102 is uploaded or updated.

FIG. 4 is a flowchart representative of example machine readable instructions and/or example operations 400 that may be executed, instantiated, and/or performed by programmable circuitry to validate the accuracy of an AI model. The example machine-readable instructions and/or the example operations 400 of FIG. 4 include the user 150 accessing, retrieving, receiving, or obtaining the AI model 102 (block 402). For example the user 150 may obtain the AI model 102 through the interface circuitry 152 of the user 150. In some examples, the validation process proceeds from a hash of the AI model 102 as opposed to the AI model 102 itself. In such examples, the example process 400 does not obtain the AI model (block 402). The cryptographic hash circuitry 154 of the user 150 computes the model hash of the AI model 102 (block 404).

The user 150 also accesses, retrieves, receives, or obtains the signed artifact 130 (block 406). For example the user 150 may obtain the signed artifact 130 through the interface circuitry 152 of the user 150. In addition, user 150 also accesses, retrieves, receives, or obtains a trusted third party platform report (block 408). For example the user 150 may obtain the trusted third party platform report through the interface circuitry 152 of the user 150. In some examples, the trusted third party platform report verified hardware details of the TEE 104.

The platform validation circuitry 156 validates the platform report (block 410). For example, the platform validation circuitry 156 verifies that a genuine TEE performed the accuracy evaluation, and the verification is based on the signed artifact 130 and the trusted third party platform report. The cryptographic hash circuitry 154 of the user 150 decodes or extracts the AI model cryptographic hash from the signed artifact 130.

The AI model accuracy validation circuitry 158 determines if the cryptographic hash of the AI model computed by the cryptographic hash circuitry 154 of the user 150 matches the AI model cryptographic hash extracted from the signed artifact 130 (block 414). If and/or when the AI model accuracy validation circuitry 158 determines that the cryptographic hash of the AI model computed by the cryptographic hash circuitry 154 of the user 150 does not match the AI model cryptographic hash extracted from the signed artifact 130 (block 414: NO), the AI model accuracy validation circuitry 158 generates and/or otherwise communicates or causes communication indicative of the accuracy report not being trustworthy (block 416). In other words, the AI model accuracy validation circuitry 158 determines that the accuracy of the AI model 102 is not validated. After notification of the invalid model accuracy (block 318), the process 300 ends.

If and/or when the AI model accuracy validation circuitry 158 determines that the cryptographic hash of the AI model computed by the cryptographic hash circuitry 154 of the user 150 does match the AI model cryptographic hash extracted from the signed artifact 130 (block 414: YES), the AI model accuracy validation circuitry 158 generates and/or otherwise communicates or causes communication indicative of the accuracy report being trustworthy (block 418). In other words, the AI model accuracy validation circuitry 158 determines that the accuracy of the AI model 102 has been validated.

When the accuracy of the AI model is validated, the user 150 can trigger or enable an action (block 420). For example, if the user 150 is in a medical setting, a robot used in a surgical procedure that implements the AI model 102 may be enabled after the accuracy of the AI model 102 is validated. In another example, if the user 150 is in a vehicle, the vehicle or a subsystem of the vehicle that implements the AI model 102 may be enabled after the accuracy of the AI model 102 is validated. In other example, if the user 150 is incorporated into secure communications (e.g., communications with a bank or other financial institution), security protocols that implement the AI model 102 may be enabled after the accuracy of the AI model 102 is validated. In some examples, actions may be prevented when the AI model accuracy validation circuitry 158 determines that the accuracy of the AI model 102 is not validated (block 416).

FIG. 5 is a block diagram of an example programmable circuitry platform 500 structured to execute and/or instantiate the example machine-readable instructions and/or the example operations of FIGS. 3 and/or to implement the accuracy evaluation circuitry 100 and/or the user 150 of FIG. 1. The programmable circuitry platform 500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, FPGAs, microprocessors, CPUs, GPUs, DSPs, and/or microcontrollers from any desired family or manufacturer. The programmable circuitry 512 may be implemented by one or more semiconductor based (e.g., silicon based) devices. In the example in which the programmable circuitry 512 implements the accuracy evaluation circuitry 100, the programmable circuitry 512 implements the interface circuitry 106 of the accuracy evaluation circuitry 100, the accuracy statistic computation circuitry 112, the cryptographic hash circuitry 114 of the accuracy evaluation circuitry 100, the security manifest generation circuitry 116, and the platform key generation circuitry 118. In the example in which the programmable circuitry 512 implements the user 150, the programmable circuitry 512 implements the interface circuitry 152 of the user 150, the cryptographic hash circuitry 154 of the user 150, the platform validation circuitry 156, and the AU model accuracy validation circuitry 158.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, an audio sensor, a microphone, a camera (still or video), a keyboard, a button, a mouse, a touchscreen, a trackpad, a trackball, an isopoint device, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 532, which may be implemented by the machine readable instructions of FIGS. 3 and/or 4, may be stored in the mass storage device 528, in the volatile memory 514, in the non-volatile memory 516, and/or on at least one non-transitory computer readable storage medium such as a CD or DVD which may be removable.

FIG. 6 is a block diagram of an example implementation of the programmable circuitry 512 of FIG. 5. In this example, the programmable circuitry 512 of FIG. 5 is implemented by a microprocessor 600. For example, the microprocessor 600 may be a general-purpose microprocessor (e.g., general-purpose microprocessor circuitry). The microprocessor 600 executes some or all of the machine-readable instructions of the flowcharts of FIGS. 3 and/or 4 to effectively instantiate the circuitry of FIG. 1 as logic circuits to perform operations corresponding to those machine readable instructions. In some such examples, the circuitry of FIG. 1 is instantiated by the hardware circuits of the microprocessor 600 in combination with the machine-readable instructions. For example, the microprocessor 600 may be implemented by multi-core hardware circuitry such as a CPU, a DSP, a GPU, an XPU, etc. Although it may include any number of example cores 602 (e.g., 1 core), the microprocessor 600 of this example is a multi-core semiconductor device including N cores. The cores 602 of the microprocessor 600 may operate independently or may cooperate to execute machine readable instructions. For example, machine code corresponding to a firmware program, an embedded software program, or a software program may be executed by one of the cores 602 or may be executed by multiple ones of the cores 602 at the same or different times. In some examples, the machine code corresponding to the firmware program, the embedded software program, or the software program is split into threads and executed in parallel by two or more of the cores 602. The software program may correspond to a portion or all of the machine readable instructions and/or operations represented by the flowcharts of FIGS. 3 and/or 4.

The cores 602 may communicate by a first example bus 604. In some examples, the first bus 604 may be implemented by a communication bus to effectuate communication associated with one(s) of the cores 602. For example, the first bus 604 may be implemented by at least one of an Inter-Integrated Circuit (I2C) bus, a Serial Peripheral Interface (SPI) bus, a PCI bus, or a PCIe bus. Additionally or alternatively, the first bus 604 may be implemented by any other type of computing or electrical bus. The cores 602 may obtain data, instructions, and/or signals from one or more external devices by example interface circuitry 606. The cores 602 may output data, instructions, and/or signals to the one or more external devices by the interface circuitry 606. Although the cores 602 of this example include example local memory 620 (e.g., Level 1 (L1) cache that may be split into an L1 data cache and an L1 instruction cache), the microprocessor 600 also includes example shared memory 610 that may be shared by the cores (e.g., Level 2 (L2 cache)) for high-speed access to data and/or instructions. Data and/or instructions may be transferred (e.g., shared) by writing to and/or reading from the shared memory 610. The local memory 620 of each of the cores 602 and the shared memory 610 may be part of a hierarchy of storage devices including multiple levels of cache memory and the main memory (e.g., the main memory 514, 516 of FIG. 5). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 602 may be referred to as a CPU, DSP, GPU, etc., or any other type of hardware circuitry. Each core 602 includes control unit circuitry 614, arithmetic and logic (AL) circuitry (sometimes referred to as an ALU) 616, a plurality of registers 618, the local memory 620, and a second example bus 622. Other structures may be present. For example, each core 602 may include vector unit circuitry, single instruction multiple data (SIMD) unit circuitry, load/store unit (LSU) circuitry, branch/jump unit circuitry, floating-point unit (FPU) circuitry, etc. The control unit circuitry 614 includes semiconductor-based circuits structured to control (e.g., coordinate) data movement within the corresponding core 602. The AL circuitry 616 includes semiconductor-based circuits structured to perform one or more mathematic and/or logic operations on the data within the corresponding core 602. The AL circuitry 616 of some examples performs integer based operations. In other examples, the AL circuitry 616 also performs floating-point operations. In yet other examples, the AL circuitry 616 may include first AL circuitry that performs integer-based operations and second AL circuitry that performs floating-point operations. In some examples, the AL circuitry 616 may be referred to as an Arithmetic Logic Unit (ALU).

The registers 618 are semiconductor-based structures to store data and/or instructions such as results of one or more of the operations performed by the AL circuitry 616 of the corresponding core 602. For example, the registers 618 may include vector register(s), SIMD register(s), general-purpose register(s), flag register(s), segment register(s), machine-specific register(s), instruction pointer register(s), control register(s), debug register(s), memory management register(s), machine check register(s), etc. The registers 618 may be arranged in a bank as shown in FIG. 6. Alternatively, the registers 618 may be organized in any other arrangement, format, or structure, such as by being distributed throughout the core 602 to shorten access time. The second bus 622 may be implemented by at least one of an I2C bus, a SPI bus, a PCI bus, or a PCIe bus.

Each core 602 and/or, more generally, the microprocessor 600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 600 is a semiconductor device fabricated to include many transistors interconnected to implement the structures described above in one or more integrated circuits (ICs) contained in one or more packages.

The microprocessor 600 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 600, in the same chip package as the microprocessor 600 and/or in one or more separate packages from the microprocessor 600.

FIG. 7 is a block diagram of another example implementation of the programmable circuitry 512 of FIG. 5. In this example, the programmable circuitry 512 is implemented by FPGA circuitry 700. For example, the FPGA circuitry 700 may be implemented by an FPGA. The FPGA circuitry 700 can be used, for example, to perform operations that could otherwise be performed by the example microprocessor 600 of FIG. 6 executing corresponding machine readable instructions. However, once configured, the FPGA circuitry 700 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 600 of FIG. 6 described above (which is a general purpose device that may be programmed to execute some or all of the machine readable instructions represented by the flowchart(s) of FIGS. 3 and/or 4 but whose interconnections and logic circuitry are fixed once fabricated), the FPGA circuitry 700 of the example of FIG. 7 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3 and/or 4. In particular, the FPGA circuitry 700 may be thought of as an array of logic gates, interconnections, and switches. The switches can be programmed to change how the logic gates are interconnected by the interconnections, effectively forming one or more dedicated logic circuits (unless and until the FPGA circuitry 700 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3 and/or 4. As such, the FPGA circuitry 700 may be configured and/or structured to effectively instantiate some or all of the operations/functions corresponding to the machine readable instructions of the flowchart(s) of FIGS. 3 and/or 4 as dedicated logic circuits to perform the operations/functions corresponding to those software instructions in a dedicated manner analogous to an ASIC. Therefore, the FPGA circuitry 700 may perform the operations/functions corresponding to the some or all of the machine readable instructions of FIGS. 3 and/or 4 faster than the general-purpose microprocessor can execute the same.

In the example of FIG. 7, the FPGA circuitry 700 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 700 of FIG. 7 may access and/or load the binary file to cause the FPGA circuitry 700 of FIG. 7 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 700 of FIG. 7 to cause configuration and/or structuring of the FPGA circuitry 700 of FIG. 7, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 700 of FIG. 7 may access and/or load the binary file to cause the FPGA circuitry 700 of FIG. 7 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 700 of FIG. 7 to cause configuration and/or structuring of the FPGA circuitry 700 of FIG. 7, or portion(s) thereof.

The FPGA circuitry 700 of FIG. 7, includes example input/output (I/O) circuitry 702 to obtain and/or output data to/from example configuration circuitry 704 and/or external hardware 706. For example, the configuration circuitry 704 may be implemented by interface circuitry that may obtain a binary file, which may be implemented by a bit stream, data, and/or machine-readable instructions, to configure the FPGA circuitry 700, or portion(s) thereof. In some such examples, the configuration circuitry 704 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 706 may be implemented by external hardware circuitry. For example, the external hardware 706 may be implemented by the microprocessor 600 of FIG. 6.

The FPGA circuitry 700 also includes an array of example logic gate circuitry 708, a plurality of example configurable interconnections 710, and example storage circuitry 712. The logic gate circuitry 708 and the configurable interconnections 710 are configurable to instantiate one or more operations/functions that may correspond to at least some of the machine readable instructions of FIGS. 3 and/or 4 and/or other desired operations. The logic gate circuitry 708 shown in FIG. 7 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 708 to enable configuration of the electrical structures and/or the logic gates to form circuits to perform desired operations/functions. The logic gate circuitry 708 may include other electrical structures such as look-up tables (LUTs), registers (e.g., flip-flops or latches), multiplexers, etc.

The configurable interconnections 710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 708 to program desired logic circuits.

The storage circuitry 712 of the illustrated example is structured to store result(s) of the one or more of the operations performed by corresponding logic gates. The storage circuitry 712 may be implemented by registers or the like. In the illustrated example, the storage circuitry 712 is distributed amongst the logic gate circuitry 708 to facilitate access and increase execution speed.

The example FPGA circuitry 700 of FIG. 7 also includes example dedicated operations circuitry 714. In this example, the dedicated operations circuitry 714 includes special purpose circuitry 716 that may be invoked to implement commonly used functions to avoid the need to program those functions in the field. Examples of such special purpose circuitry 716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 700 may also include example general purpose programmable circuitry 718 such as an example CPU 720 and/or an example DSP 722. Other general purpose programmable circuitry 718 may additionally or alternatively be present such as a GPU, an XPU, etc., that can be programmed to perform other operations.

Although FIGS. 6 and 7 illustrate two example implementations of the programmable circuitry 512 of FIG. 5, many other approaches are contemplated. For example, FPGA circuitry may include an on-board CPU, such as one or more of the example CPU 720 of FIG. 6. Therefore, the programmable circuitry 512 of FIG. 5 may additionally be implemented by combining at least the example microprocessor 600 of FIG. 6 and the example FPGA circuitry 700 of FIG. 7. In some such hybrid examples, one or more cores 602 of FIG. 6 may execute a first portion of the machine readable instructions represented by the flowchart(s) of FIGS. [Flowcharts] to perform first operation(s)/function(s), the FPGA circuitry 700 of FIG. 7 may be configured and/or structured to perform second operation(s)/function(s) corresponding to a second portion of the machine readable instructions represented by the flowcharts of FIGS. 3 and/or 4], and/or an ASIC may be configured and/or structured to perform third operation(s)/function(s) corresponding to a third portion of the machine readable instructions represented by the flowcharts of FIGS. 3 and/or 4.

It should be understood that some or all of the circuitry of FIG. 1 may, thus, be instantiated at the same or different times. For example, same and/or different portion(s) of the microprocessor 600 of FIG. 6 may be programmed to execute portion(s) of machine-readable instructions at the same and/or different times. In some examples, same and/or different portion(s) of the FPGA circuitry 700 of FIG. 7 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 600 of FIG. 6 may execute machine readable instructions in one or more threads executing concurrently and/or in series. In some examples, the FPGA circuitry 700 of FIG. 7 may be configured and/or structured to carry out operations/functions concurrently and/or in series. Moreover, in some examples, some or all of the circuitry of FIG. 1 may be implemented within one or more virtual machines and/or containers executing on the microprocessor 600 of FIG. 6.

In some examples, the programmable circuitry 512 of FIG. 5 may be in one or more packages. For example, the microprocessor 600 of FIG. 6 and/or the FPGA circuitry 700 of FIG. 7 may be in one or more packages. In some examples, an XPU may be implemented by the programmable circuitry 512 of FIG. 5, which may be in one or more packages. For example, the XPU may include a CPU (e.g., the microprocessor 600 of FIG. 6, the CPU 720 of FIG. 7, etc.) in one package, a DSP (e.g., the DSP 722 of FIG. 7) in another package, a GPU in yet another package, and an FPGA (e.g., the FPGA circuitry 700 of FIG. 7) in still yet another package.

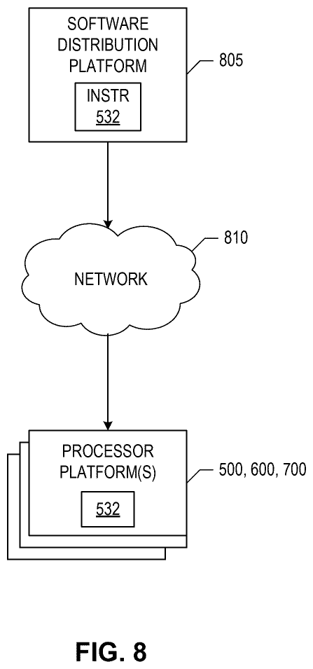

A block diagram illustrating an example software distribution platform 805 to distribute software such as the example machine readable instructions 532 of FIG. 5 to other hardware devices (e.g., hardware devices owned and/or operated by third parties from the owner and/or operator of the software distribution platform) is illustrated in FIG. 8. The example software distribution platform 805 may be implemented by any computer server, data facility, cloud service, etc., capable of storing and transmitting software to other computing devices. The third parties may be customers of the entity owning and/or operating the software distribution platform 805. For example, the entity that owns and/or operates the software distribution platform 805 may be a developer, a seller, and/or a licensor of software such as the example machine readable instructions 532 of FIG. 5. The third parties may be consumers, users, retailers, OEMs, etc., who purchase and/or license the software for use and/or re-sale and/or sub-licensing. In the illustrated example, the software distribution platform 805 includes one or more servers and one or more storage devices. The storage devices store the machine readable instructions 532, which may correspond to the example machine readable instructions of FIGS. 3 and/or 4, as described above. The one or more servers of the example software distribution platform 805 are in communication with an example network 810, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 532 from the software distribution platform 805. For example, the software, which may correspond to the example machine readable instructions of FIGS. 3 and/or 4, may be downloaded to the example programmable circuitry platform 500, which is to execute the machine readable instructions 532 to implement the accuracy evaluation circuitry 100 and/or the user 150. In some examples, one or more servers of the software distribution platform 805 periodically offer, transmit, and/or force updates to the software (e.g., the example machine readable instructions 532 of FIG. 5) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that validate AI model accuracy. Monetization of AI models is based on their capabilities denoted by the accuracy. Accuracy could mean resistance to false-positives in case of medical image detection of tumors, accuracy in returned language in case of LLMs, accuracy of facts in responses of LLMs. Examples disclosed herein avoid spending expensive resources to reproduce accuracy results of AI models. In addition, examples disclosed herein enable measurement of accuracy evaluations of AI models, cryptographically signing of the accuracy results, and allowance of third parties to validate the endorsed accuracy results. In some examples, to make the accuracy evaluation trustworthy, remote attestation capabilities of trusted execution environments (TEE) like Intel Software Guard Extension (SGX) or Intel Trust Domain Extension (TDX) are leveraged. Disclosed systems, apparatus, articles of manufacture, and methods improve the efficiency of using a computing device by enabling or disabling features of electronic devices based on validation of AI model accuracy. Disclosed systems, apparatus, articles of manufacture, and methods are accordingly directed to one or more improvement(s) in the operation and/or safety of a machine such as a computer or other electronic and/or mechanical device.

Example systems, apparatus, methods, and articles of manufacture to validate the accuracy of artificial intelligence models are disclosed. Example 1 includes an example apparatus that includes machine-readable instructions; and at least one processor circuit to be programmed by the machine-readable instructions to: compute accuracy statistics of an artificial intelligence model using software applied by a trusted third party and an input data set; determine a signed artifact based on (1) the accuracy statistics indicative of the accuracy of the artificial intelligence model, (2) the software applied by the trusted third party, and (3) the input data set; and communicate the signed artifact to a user of the artificial intelligence model.

Example 2 include the apparatus of Example 1, wherein one or more of the at least one processor circuit is to generate a cryptographic hash of the artificial intelligence model, wherein the signed artifact is based on the cryptographic hash of the artificial intelligence model.

Example 3 includes the apparatus of any of Examples 1 or 2, wherein one or more of the at least one processor circuit is to: generate a cryptographic hash of the software applied by the trusted third party; and generate a cryptographic hash of the input data set, wherein the signed artifact is based on the cryptographic hash of the software applied by the trusted third party and the cryptographic hash of the input data set.

Example 4 includes the apparatus of Example 3, wherein one or more of the at least one processor circuit is to: generate a cryptographic hash of the artificial intelligence model; generate a security manifest based on the cryptographic hash of the artificial intelligence model, the cryptographic hash of the software applied by the trusted third party, and the cryptographic hash of the input data set; and prepare a platform key based on a hardware platform used to validate the accuracy of the artificial intelligence model.

Example 5 includes the apparatus of Example 4, wherein one or more of the at least one processor circuit is to: perform an integrity check based on the security manifest and the platform key; and compute the accuracy statistics based on passage of the integrity check.

Example 6 includes the apparatus of any of Examples 4 or 5, wherein the signed artifact is based on the platform key.

Example 7 includes at least one non-transitory machine-readable medium that includes machine-readable instructions to cause at least one processor circuit to at least: compute accuracy statistics of an artificial intelligence model using software applied by a trusted third party and an input data set; determine a signed artifact based on (1) the accuracy statistics indicative of the accuracy of the artificial intelligence model, (2) the software applied by the trusted third party, and (3) the input data set; and communicate the signed artifact to a user of the artificial intelligence model.

Example 8 includes the machine-readable medium of Example 7, wherein the instructions are to cause one or more of the at least one processor circuit to generate a cryptographic hash of the artificial intelligence model, wherein the signed artifact is based on the cryptographic hash of the artificial intelligence model.

Example 9 includes the machine-readable medium of any of Examples 7 or 8, wherein the instructions are to cause one or more of the at least one processor circuit to: generate a cryptographic hash of the software applied by the trusted third party; and generate a cryptographic hash of the input data set, wherein the signed artifact is based on the cryptographic hash of the software applied by the trusted third party and the cryptographic hash of the input data set.

Example 10 includes the machine-readable medium of Example 9, wherein the instructions are to cause one or more of the at least one processor circuit to: generate a cryptographic hash of the artificial intelligence model; generate a security manifest based on the cryptographic hash of the artificial intelligence model, the cryptographic hash of the software applied by the trusted third party, and the cryptographic hash of the input data set; and prepare a platform key based on a hardware platform used to validate the accuracy of the artificial intelligence model.

Example 11 includes the machine-readable medium of Example 10, wherein the instructions are to cause one or more of the at least one processor circuit to: perform an integrity check based on the security manifest and the platform key; and compute the accuracy statistics based on passage of the integrity check.

Example 12 includes the machine-readable medium of Example 10, wherein the signed artifact is based on the platform key.

Example 13 includes a method that includes computing, by at least one processor circuit programmed by at least one instruction, accuracy statistics of an artificial intelligence model using software applied by a trusted third party and an input data set; determining, by at least one processor circuit programmed by at least one instruction, a signed artifact based on (1) the accuracy statistics indicative of the accuracy of the artificial intelligence model, (2) the software applied by the trusted third party, and (3) the input data set; and communicating, by at least one processor circuit programmed by at least one instruction, the signed artifact to a user of the artificial intelligence model.

Example 14 includes the method of Example 13, further including generating a cryptographic hash of the artificial intelligence model, wherein the signed artifact is based on the cryptographic hash of the artificial intelligence model.

Example 15 includes the method of any of Examples 13 or 14, further including: generating a cryptographic hash of the software applied by the trusted third party; and generating a cryptographic hash of the input data set, wherein the signed artifact is based on the cryptographic hash of the software applied by the trusted third party and the cryptographic hash of the input data set.

Example 16 includes the method of Example 15, further including: generating a cryptographic hash of the artificial intelligence model; generating a security manifest based on the cryptographic hash of the artificial intelligence model, the cryptographic hash of the software applied by the trusted third party, and the cryptographic hash of the input data set; and preparing a platform key based on a hardware platform used to validate the accuracy of the artificial intelligence model.

Example 17 includes the method of Example 16, further including: performing an integrity check based on the security manifest and the platform key; and computing the accuracy statistics based on passage of the integrity check.

Example 18 includes the method of any of Examples 16 or 17, wherein the signed artifact is based on the platform key.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
machine-readable instructions; and
at least one processor circuit to be programmed by the machine-readable instructions to:
compute accuracy statistics of an artificial intelligence model using software applied by a trusted third party and an input data set;
determine a signed artifact based on: (1) the accuracy statistics indicative of the accuracy of the artificial intelligence model, (2) the software applied by the trusted third party, and (3) the input data set; and
communicate the signed artifact to a user of the artificial intelligence model.

2. The apparatus of claim 1, wherein one or more of the at least one processor circuit is to generate a cryptographic hash of the artificial intelligence model, wherein the signed artifact is based on the cryptographic hash of the artificial intelligence model.

3. The apparatus of claim 1, wherein one or more of the at least one processor circuit is to:
generate a cryptographic hash of the software applied by the trusted third party; and
generate a cryptographic hash of the input data set, wherein the signed artifact is based on the cryptographic hash of the software applied by the trusted third party and the cryptographic hash of the input data set.

4. The apparatus of claim 3, wherein one or more of the at least one processor circuit is to:
generate a cryptographic hash of the artificial intelligence model;
generate a security manifest based on the cryptographic hash of the artificial intelligence model, the cryptographic hash of the software applied by the trusted third party, and the cryptographic hash of the input data set; and
prepare a platform key based on a hardware platform used to validate the accuracy of the artificial intelligence model.

5. The apparatus of claim 4, wherein one or more of the at least one processor circuit is to:
perform an integrity check based on the security manifest and the platform key; and
compute the accuracy statistics based on passage of the integrity check.

6. The apparatus of claim 4, wherein the signed artifact is based on the platform key.

7. At least one non-transitory machine-readable medium comprising machine-readable instructions to cause at least one processor circuit to at least:
compute accuracy statistics of an artificial intelligence model using software applied by a trusted third party and an input data set;
determine a signed artifact based on: (1) the accuracy statistics indicative of the accuracy of the artificial intelligence model, (2) the software applied by the trusted third party, and (3) the input data set; and
communicate the signed artifact to a user of the artificial intelligence model.

8. The machine-readable medium of claim 7, wherein the instructions are to cause one or more of the at least one processor circuit to generate a cryptographic hash of the artificial intelligence model, wherein the signed artifact is based on the cryptographic hash of the artificial intelligence model.

9. The machine-readable medium of claim 7, wherein the instructions are to cause one or more of the at least one processor circuit to:
generate a cryptographic hash of the software applied by the trusted third party; and
generate a cryptographic hash of the input data set, wherein the signed artifact is based on the cryptographic hash of the software applied by the trusted third party and the cryptographic hash of the input data set.

10. The machine-readable medium of claim 9, wherein the instructions are to cause one or more of the at least one processor circuit to:
generate a cryptographic hash of the artificial intelligence model;
generate a security manifest based on the cryptographic hash of the artificial intelligence model, the cryptographic hash of the software applied by the trusted third party, and the cryptographic hash of the input data set; and
prepare a platform key based on a hardware platform used to validate the accuracy of the artificial intelligence model.

11. The machine-readable medium of claim 10, wherein the instructions are to cause one or more of the at least one processor circuit to:
perform an integrity check based on the security manifest and the platform key; and
compute the accuracy statistics based on passage of the integrity check.

12. The machine-readable medium of claim 10, wherein the signed artifact is based on the platform key.

13. A method comprising:
computing, by at least one processor circuit programmed by at least one instruction, accuracy statistics of an artificial intelligence model using software applied by a trusted third party and an input data set;
determining, by at least one processor circuit programmed by at least one instruction, a signed artifact based on: (1) the accuracy statistics indicative of the accuracy of the artificial intelligence model, (2) the software applied by the trusted third party, and (3) the input data set; and
communicating, by at least one processor circuit programmed by at least one instruction, the signed artifact to a user of the artificial intelligence model.

14. The method of claim 13, further including generating a cryptographic hash of the artificial intelligence model, wherein the signed artifact is based on the cryptographic hash of the artificial intelligence model.

15. The method of claim 13, further including:
generating a cryptographic hash of the software applied by the trusted third party; and
generating a cryptographic hash of the input data set, wherein the signed artifact is based on the cryptographic hash of the software applied by the trusted third party and the cryptographic hash of the input data set.

16. The method of claim 15, further including:
generating a cryptographic hash of the artificial intelligence model;
generating a security manifest based on the cryptographic hash of the artificial intelligence model, the cryptographic hash of the software applied by the trusted third party, and the cryptographic hash of the input data set; and
preparing a platform key based on a hardware platform used to validate the accuracy of the artificial intelligence model.

17. The method of claim 16, further including:
performing an integrity check based on the security manifest and the platform key; and
computing the accuracy statistics based on passage of the integrity check.

18. The method of claim 16, wherein the signed artifact is based on the platform key.
